(19) United States
(12) Patent Application Publication
(10) Pub. No.: US 2008/0034169 A1
(43) Pub. Date: Feb. 7, 2008

(54) Pseudo-FIFO memory configuration using dual FIFO memory stacks operated by atomic instructions

(76) Inventors: Barrett Trask, Lafayette, CO (US); Jaroslav Andrew Delapedraja, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/500,127

(22) Filed: Aug. 7, 2006

(51) Int. Cl. G06F 13/00

(52) U.S. Cl. 711/154

(57) ABSTRACT

Pseudo-FIFO (first in, first out) memory apparatus comprises: a processor operative to execute atomic instructions; a first memory portion operated by the processor as a primary last in, first out (LIFO) memory stack using atomic instructions; and a second memory portion operated by the processor as a backup LIFO memory stack using atomic instructions upon detection of a starvation condition in the primary LIFO memory stack.

### COPYRIGHT NOTICE

A portion of the disclosure of this application contains material which is subject to copyright protection. The copyright owner has no objection to the facsimile reproduction by anyone of any patent document published from this application, as it may appear in the Patent and Trademark Office patent files or records, but otherwise expressly reserves all rights whatsoever in said copyright works.

### BACKGROUND

One solution to provide consistency for a memory structure implementing a first-in-first-out (FIFO) memory stack is to create a courser grained locking. In this solution, a spinlock or other mutex may be used to provide mutual exclusion for competing threads. This allows several memory accesses to be performed atomically by one thread, keeping both head and tail pointers consistent from the view of other threads.

A disadvantage of this approach is a loss of performance and throughput versus using atomic instructions. Acquiring a spinlock is orders of magnitude slower than performing a single atomic instruction. This is primarily due to the necessary interprocessor communication and arbitration associated with spinlocks. Throughput is diminished because the critical section (area that is single threaded) is now larger since it includes acquiring and dropping the spinlock as well as updating the memory references.

To configure a FIFO memory structure without locks for improved performance, the use of atomic operations (i.e. compare-and-swap) are proposed to build load-linked/store conditional (LL/SC) operations, which allow arbitrarily sized data to be updated atomically. This is accomplished by having each thread trying to update the structure keep track of data version information, which is used to determine whether the update operation (SC) will succeed. In addition to version tracking, each node also keeps track of thread counts and other information that indicates when the node can safely be freed or reused. The LL/SC operations can further be utilized to build a queue that implements the desired FIFO behavior. An example of such a lock-free solution is disclosed in the paper entitled “Bringing Practical Lock-Free Synchronization to 64-Bit Applications” by Simon Doherty et al., published in PODC'04, Jul. 25-28, 2004 at St. John's, Newfoundland, Canada.

While the above approach certainly has its appeal, there are disadvantages to the proposed solution which apply if strict FIFO ordering is not needed. For example, complexity involved with keeping track of version and thread information is significant and the problems addressed by these can be addressed more simply. Also, several compare-and-swap operations are needed for each successful queueing operation, mostly for version and other information updates. This may in turn lead to higher contention between parallel threads. The solution also adds more complication to the error paths if the compare-and-swap fails. Finally, the complexity of the metadata makes it more difficult to inline the queue elements (i.e. a metadata structure must be allocated as a container for the queued item). Since more than just a pointer field is needed, more complicated offsets/structures would be needed.

### SUMMARY

In accordance with one aspect of the present invention, pseudo-FIFO (first in, first out) memory apparatus comprises: a processor operative to execute atomic instructions; a first memory portion operated by the processor as a primary last in, first out (LIFO) memory stack using atomic instructions; and a second memory portion operated by the processor as a backup LIFO memory stack using atomic instructions upon detection of a starvation condition in the primary LIFO memory stack.

### BRIEF DESCRIPTION OF THE DRAWINGS

FIG. 1 is a block diagram schematic of an exemplary pseudo-FIFO memory configuration.

FIG. 2 is a stack memory diagram of default and backup LIFO memory stacks exemplifying one state of pseudo-FIFO memory operation.

FIG. 3 is a stack memory diagram of default and backup LIFO memory stacks exemplifying another state of pseudo-FIFO memory operation.

FIG. 4 is a stack memory diagram of default and backup LIFO memory stacks exemplifying yet another state of pseudo-FIFO memory operation.

FIG. 5 is a stack memory diagram of default and backup LIFO memory stacks exemplifying a further state of pseudo-FIFO memory operation.

FIG. 6 is a flowchart of an exemplary method of operating the pseudo-FIFO memory configuration.

### DETAILED DESCRIPTION OF THE INVENTION

The present embodiment uses dual last in, first out (LIFO) memory stacks in implementing a pseudo-FIFO memory configuration. One problem in using LIFO memory configurations is that of starvation, or indefinite queuing of a work item. When using a LIFO memory stack data structure in a consumer-producer application, starvation may occur if the consumer(s) can not keep up with the producer(s). In such a situation, the first work item added to or “pushed” onto the LIFO stack will never be retrieved or “popped”. Previous starvation prevention techniques involved acquiring locks (to implement a true FIFO memory configuration), which reduces performance and/or requires keeping complicated statistics. Starvation is prevented by the present embodiment using a memory stack data structure having a LIFO property that does not normally make such guarantees. That is, the last data or work item to be inserted will also be the first item retrieved. The converse property is the cause for starvation, i.e. the first item inserted will be the last item retrieved. If the stack is never emptied, because the rate of inserts exceeds the rate of removes, the last item on the stack (first item inserted) will never be acted upon or, in other words, starved.

The present embodiment also uses atomic processor instructions in implementing the pseudo-FIFO memory configuration using the dual LIFO memory stacks. Typically, atomic instructions are not used for a structure that operates with FIFO (First In, First Out) behavior. This is because the atomic instructions only provide consistency for a single memory address. If a queue (having the desired first in, first out property) is implemented as a list with head and tail pointers, it cannot use atomic operations to update both head and tail pointers simultaneously. It is necessary to update both pointers when the list is either becoming empty because the last item was removed or was empty when an item was inserted (first item being inserted).

While the atomic processor instructions and predefined code macros used by the pseudo-FIFO memory embodiment are considered well known to those skilled in the pertinent art, they will be nonetheless described herein as they are the building blocks of the pseudo-FIFO memory embodiment.

### Compare-and-Swap

The atomic instruction, compare-and-swap (also called compare-and-exchange), is a basic synchronization mechanism implemented in hardware in modern versions of microprocessors, like the Itanium® processor family manufactured by Intel Corporation, for example. The premise is that when the processor confronts a compare-and-swap instruction, it reads the value of a memory location, computes a new value for the location based on this value, and then executes the compare-and-swap operation. The instruction includes a value to be compared (the initial value read), a value to be written (the computed value), and a memory location.

During execution of the instruction, if the memory location still equals the compare value, the computed value is written by the processor into the designated memory location atomically (i.e. no other compare-and-swap or memory operation can interfere). On the other hand, if the value in the memory location is not the same as the compare value, the processor does not do a write to the location because the computed value is now invalid. The previous value of the memory location is returned to allow the processor to determine if the operation succeeded. If the return value and the compare value match, the instruction succeeded and the computed value was written.

Herebelow is pseudocode for the compare-and-swap instruction (executed atomically):

compare_and_swap(addr, compare, computed)
{
old = *addr;
if (*addr == compare) {
*addr = computed;
}
return (old); 1
}

### List Operations

The list or stack operations operate by adding an element or removing (retrieving) an element by an atomic write of the head pointer to the list. A “steal” operation which moves an element from one list to another is included. The following pseudocode serves to demonstrate how this can be done. Note that these operations provide the LIFO stack behavior.

```
atomic_list_add(list_head_addr, first_item, last_item)
  {
  list = list_head_addr;
  do {
  old_head = *list;
  last_item->next = old_head;
  prev = compare_and_swap(list, old_head, first_item);
  } while (prev != old_head);
  }
atomic_list_remove(list_head_addr)
  {
  list =list_head_addr;
  old_head = NULL;
  prev = *list;
  while (prev != old_head && prev != NULL) {
  old_head =list;
  old_head_next = old_head->next;
  prev = compare_and_swap(list, old_head, old_head_next);
  }
  prev->next = NULL;
  return (prev);
  }
atomic_list_steal(list_head_addr)
  {
  list = list_head_addr;
  old_head = NULL;
  new_head = NULL;
  prev = *list;
  while (prev != old_head && prev != NULL) {
  old_head = *list;
  prev = compare_and_swap(list, old_head, new_head);
  }
  return (prev);
  }
```

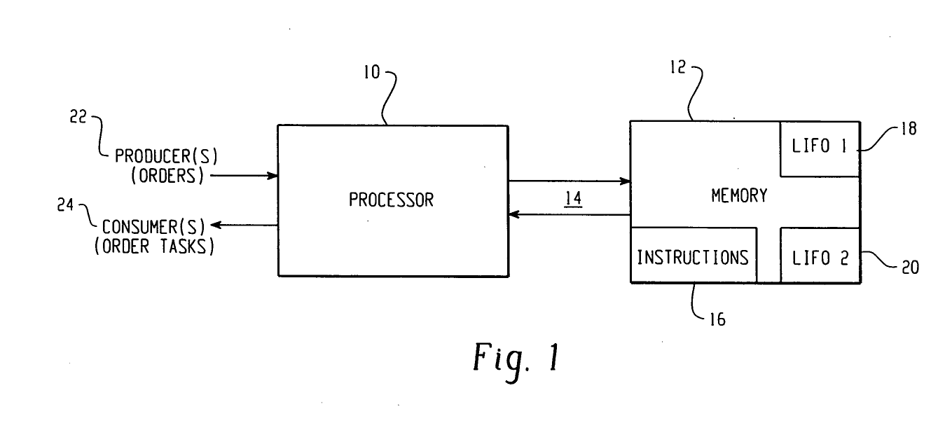

Now that these basic building blocks or instructions have been described, an embodiment of a pseudo-FIFO memory stack using two LIFO memory stacks in a producer-consumer environment may now be described. Referring to the block diagram schematic of FIG. 1, a processor 10 which may be of the Itanium family manufactured by Intel Corp., for example, may be coupled to a memory subsystem 12 over a bus 14 which may be bidirectional. While only one processor is shown by way of example, it is understood that multiple processors may be included and coupled to the memory subsystem 12 over the common bus 14 without deviating from the principles of the present invention. In addition, while the basic building blocks or instructions were described hereabove in connection with pseudocode for an understanding of these operations, it is understood that execution of each instruction in the processor 10 is performed in hardware so that the two step operations thereof may be executed by the processor preferably in one processor cycle.

The memory subsystem 12 may be comprised of random access memory (RAM), nonvolatile memory, processor cache, flash memory and the like, for example. In the present embodiment, the memory 12 comprises one or more portions 16 which store instructions, including atomic instructions, executable by the processor 10 or the multiple processors. In addition, the memory 12 may include portions 18 and 20 configured as two(2) LIFO memory stacks, LIFO 1 and LIFO 2, respectively. The LIFO memory stacks 18 and 20 are operational together to store work or data items as a pseudo-FIFO memory stack as will be better understood from the following description. The processor 10 may take in work items from a plurality of producers 22 and stores them into the LIFO stacks 18 and 20 using a predetermined method which will be described in greater detail herebelow. The work items, which may be customer orders, for example, are removed or retrieved from the stacks 18 and 20 in a pseudo-FIFO order to be executed by the processor(s) 10 to carry out certain tasks thereof for a plurality of consumers 24 with starvation prevention.

The producers 22 and consumers 24 may be external to the processor 10, embedded in a one or more programs stored in the memory subsystem 12 and operated on by the processor 10, or a combination thereof. If embedded, the producers and consumers may be multiple threads of execution in the same program or multiple processes running on the same processor or network system, for example. A producer/consumer application, in and of itself, is generally well known to all those skilled in the pertinent art, and is used herein, by way of example, to form a working environment for the pseudo-FIFO memory configuration.

A process which is suitable for starvation prevention with multiple producers and multiple consumers will now be described. The basic concept is that each producer of the plurality 22 will produce its work items onto only one stack, like LIFO 1, which may be referred to as the primary or ‘default’ stack. If the LIFO 1 stack is empty when a work item is about to be added to the default stack 18, the processor updates a time value with the current time in a memory location designated as ‘last_empty’ time to be able to detect starvation. The processor will remove items from the ‘default’ stack 18 for consumer tasks until the difference between the current time and time value of the ‘last_empty’ memory location exceeds or crosses a starvation threshold. At this point, one of the consumers via processor intervention will “steal” the entire list of work items currently stored on the default stack 18 and move them to the other LIFO stack 20, LIFO 2, which may be referred to as the ‘backup’ stack. Thereafter, work items will be processed or retrieved for the consumers from the backup stack 20 until it is empty. This movement of the work items from the default stack 18 to the backup stack 20 will ensure against any stored item from starving. When the backup stack 20 becomes void of work items, i.e. in a null condition, consumer processing will begin on the default stack 18 again, along with checking for starvation of the work items thereof.

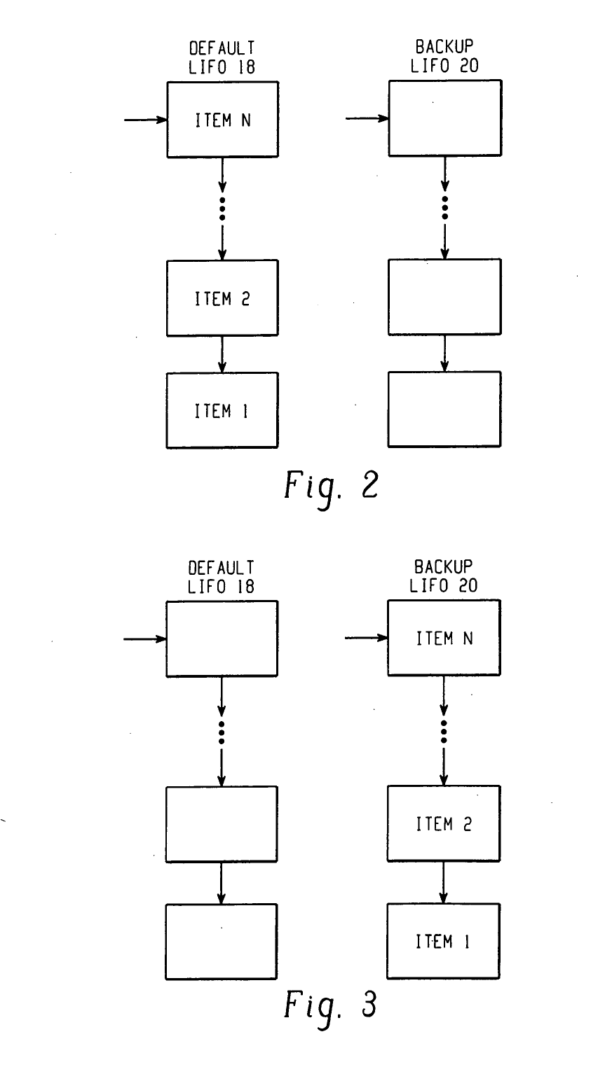

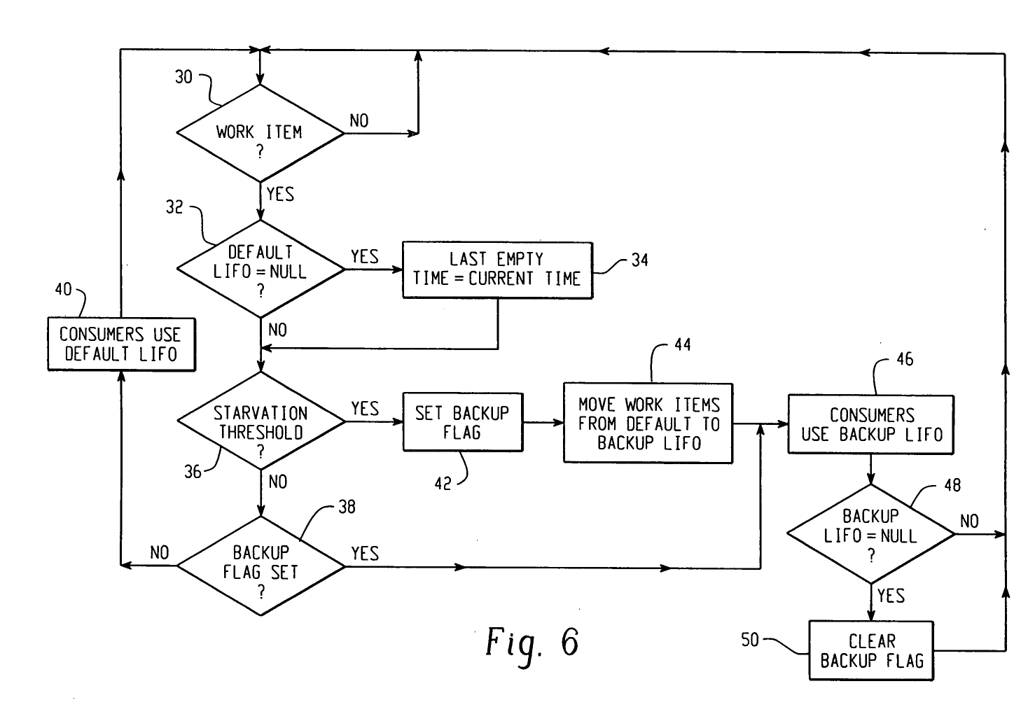

A flowchart of an exemplary method for implementing the pseudo-FIFO memory operation using the two LIFO memory stacks 18 and 20 is shown in FIG. 6. Each block of the flowchart of FIG. 6 represents one or more steps of the processor 10 using the basic building blocks or instructions described supra. In the present example, it is presumed that all work items from the producers 22 will be stored in the default memory as they are received by the processor or processors 10 as shown in the stack memory diagram of FIG. 2. In the diagram of FIG. 2, item 1 would be the first item stored and item N the last. Referring to FIGS. 1, 2 and 6, in block 30, the processor 10 monitors if a work item is received from a producer 22. When a work item is received, the processor 10 checks if the default LIFO stack 18 is empty or in a null state in block 32. If so, block 34 is executed wherein the processor 10 sets the time value of the ‘last empty’ memory location to the current time which it may retrieve from a real time clock thereof.

After execution of block 34 or if the default stack 18 is not in a null state, execution continues at block 36 wherein the processor determines if a starvation condition exists in the default stack 18. The stack memory diagram of FIG. 2 exemplifies a default stack 18 filled with work items 1 through N and an empty backup stack 20. Referring to FIG. 6, the processor may make a starvation determination by comparing the time value set in the ‘last empty’ memory location to the current time. If the time difference does not exceed a predetermined threshold time, then starvation of a work item is determined not to exist in the default memory 18 and program flow continues at block 38 wherein it is determined if a back up flag is set. The setting of the back up flag will become more evident from the description hereinbelow. If the back up flag is not set, then block 40 is executed to permit both the consumers and producers to use the default LIFO memory 18 as shown in FIG. 2.

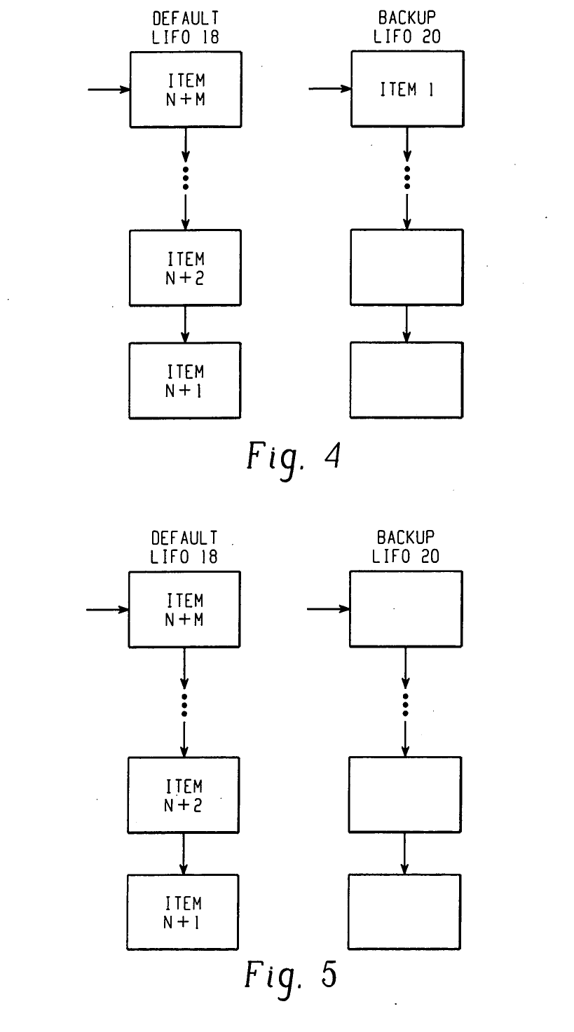

If in block 36 it is determined that the time difference exceeds the predetermined threshold time, then starvation of a work item is determined to exist in the default memory 18 which causes the program flow to be diverted to block 42 wherein the back up flag is set. In the present embodiment, the setting of the back up flag is an indication to the program that the back up memory 20 is in use. Next, in block 44, with the back up flag set, one of the consumers 24 may steal or cause all of the work items of the default memory 18, i.e. items 1 through N, to be moved to the back up LIFO memory 20 as shown by way of example in the stack memory diagram of FIG. 3. Then, in block 46, the consumers may use the backup LIFO memory stack 20 while the producers continue to add new work items N+1 through N+M to the default LIFO memory stack 18 as shown by way of example in the memory stack diagram of FIG. 4.

While the program is in a state to permit the consumers to use the backup LIFO memory stack 20, it will be monitored by block 48 to detect a depleted or null condition, i.e. no work items stored therein. If the backup LIFO memory stack 20 contains memory items, then program execution will continue at block 30 waiting to receive a new work item from a producer. Upon reception of a new work item, the program will execute blocks 32-38 as described herein above. However, since the back up flag is set, program execution will be diverted from block 38 to block 46 to permit the consumers to continue to use the backup LIFO memory stack 20. When block 48 detects a null state in the LIFO memory stack 20 as shown by way of example in the memory stack diagram of FIG. 5, it clears the backup flag in block 50 and returns to block 30. Thereafter, producers will add and consumers will retrieve work items from the default LIFO memory stack 18 as described herein above until a starvation condition is detected. In this manner, a pseudo-FIFO memory configuration is implemented using the two LIFO memory stacks 18 and 20 under the direction of the processor 10 operated by the atomic instructions.

An example of pseudocode for the pseudo-FIFO memory embodiment in the producer and consumer application using atomic instructions is shown below:

```
produce_work(item)
{
  now = get_current_time( );
  if (enqueue_stack == NULL) {
    last_empty_time = now;
  }
  atomic_increment(work_item_count);
  atomic_list_add(default_stack, item, item);
  /* Signal new work item “/
  }
  consumer( )
  {
    /* Loop forever waiting for work. “/
    do {
      /* Loop until no work available. */
      while (work_item_count > 0) {
        if (backup_stack != NULL) {
      /*
      * Exhaust this stack before looking at the
      * default stack.
      work_item = atomic_list_remove(backup_stack);
        if (work_item != NULL) {
          atomic_decrement(work_item_count);
          perform_work(work_item);
          continue;
      }
    }
    if (default_stack != NULL) {
      now = get_current_time( );
      if (ITEM_STARVING(now, last_empty)) {
        list = atomiclist_steal(default_stack);
        if (list == NULL) {
            /*
            * Another thread got it--just
            * keep looking for work.
            */
            continue;
        } else {
        /*
        * Keep a work item for myself.
        */
        work_item = list;
        list = list->next;
        atomic_decrement(work_item_count);
        /*
        * Move list to backup stack.
        */
        last = list;
        while (last && last->next != NULL) {
            last = last->next;
        }
        if (list != NULL) {
          atomic_list_add(backup_stack, list, last);
          }
            perform_work(work_item);
            continue;
          }
        }
        /*
        * Just try to grab one.
        *1
        work_item = atomic_list_remove(default_stack);
        if (work_item != NULL) {
            atomic_decrement(work_item_count);
            perform_work(work_item);
            continue;
        }
      }
    } /* While work is waiting. */
    /* Wait for signal from producer. “/
  } while (1)
}
```

The advantages of embodying starvation prevention into a dual LIFO memory data structure using atomic instructions are primarily performance speed and better parallelism, which translates to more throughput for the data structure. Higher throughput allows work to be performed more efficiently.

In the prior art, a spinlock or other mutex must be used to solve the consistency issue with a two pointer FIFO memory data structure. The lock-free FIFO implementation of Doherty et al. referenced in the Background section of the instant application adds much more complexity than Applicants' solution. If strict ordering must be honored, a true FIFO memory stack implementation must be used. Otherwise, the latency for handling any particular work item may be managed by the starvation detection technique used by the producer to determine when to steal or transfer the list of work items from the default LIFO memory stack to the backup stack. Therefore, the wait times can be as predictable, on average, as the true FIFO solution. The time to actually run the work items and the size of the consumer thread pool produces latency that is similar in both dual LIFO (pseudo-FIFO) and true FIFO solutions.

While the present invention has been described hereinabove in connection with one or more embodiments, it is understood that this presentation is merely by way of example. Accordingly, the above presentation or any its embodiments is in no way intended to limit the invention. Rather, the present invention should be construed in breadth and broad scope in accordance with the recitation of the claims appended hereto.

What is claimed is:

1. Pseudo-FIFO (first in, first out) memory apparatus comprising:
a processor operative to execute atomic instructions;
a first memory portion operated by the processor as a primary last in, first out (LIFO) memory stack using atomic instructions; and
a second memory portion operated by the processor as a backup LIFO memory stack using atomic instructions upon detection of a starvation condition in the primary LIFO memory stack.

2. The apparatus according to claim 1 wherein the processor is operative in a producer-consumer application; and wherein the processor is operative to store producer work items in the primary LIFO and retrieve consumer work items from one of the primary and backup LIFO memory stacks dependent on the detection of the starvation condition.

3. The apparatus according to claim 2 wherein the processor is operative to move work items from the primary LIFO memory stack to the backup LIFO memory stack upon detection of the starvation condition.

4. The apparatus according to claim 3 wherein the processor is operative to retrieve consumer work items from the backup LIFO memory stack after work items have been moved thereto, and to continue to store producer work items in the primary memory stack.

5. The apparatus according to claim 3 wherein the processor is operative to retrieve consumer work items from the backup LIFO memory stack after work items have been moved thereto until all said moved work items have been retrieved and thereafter, retrieve consumer work items from the primary memory stack.

6. The apparatus according to claim 1 wherein the processor is operative to detect the starvation condition in the primary LIFO memory stack by determining if a first item stored in an empty primary LIFO memory stack has exceeded a threshold time period without being retrieved.

7. The apparatus according to claim 6 wherein the processor is operative to assign a time of storage to the first item stored in an empty primary LIFO memory stack, to determine a differential time between the time of storage and a current time, and to determine if the differential time exceeds the threshold time period for starvation.

8. The apparatus according to claim 7 wherein the processor operates the backup LIFO memory stack using atomic instructions upon the determination that the differential time exceeds the threshold time period for starvation.

9. The apparatus according to claim 7 wherein the processor is operative to move the contents of the primary LIFO memory stack to the backup LIFO memory stack using atomic instructions upon the determination that the differential time exceeds the threshold time period for starvation.

10. Method of configuring a pseudo-FIFO (first in, first out) memory, said method comprising:
operating a first memory portion as a primary last in, first out (LIFO) memory stack using atomic instructions;
detecting a starvation condition in said primary LIFO memory stack; and
operating a second memory portion as a backup LIFO memory stack using atomic instructions upon said detection of the starvation condition.

11. The method according to claim 10 including:
storing producer work items in the primary LIFO; and
retrieving consumer work items from one of the primary and backup LIFO memory stacks dependent on the detection of the starvation condition.

12. The method according to claim 11 including moving work items from the primary LIFO memory stack to the backup LIFO memory stack upon detection of the starvation condition.

13. The method according to claim 12 including retrieving consumer work items from the backup LIFO memory stack after work items have been moved thereto, and continuing to store producer work items in the primary memory stack.

14. The method according to claim 12 including: retrieving consumer work items from the backup LIFO memory stack after work items have been moved thereto until all said moved work items have been retrieved; and thereafter, retrieving consumer work items from the primary memory stack.

15. The method according to claim 10 wherein the step of detecting includes determining if a first item stored in an empty primary LIFO memory stack has exceeded a threshold time period without being retrieved.

16. The method according to claim 15 including: assigning a time of storage to the first item stored in an empty primary LIFO memory stack; determining a differential time between the time of storage and a current time; and determining if the differential time exceeds the threshold time period for starvation.

17. The method according to claim 16 including operating the backup LIFO memory stack using atomic instructions upon the determination that the differential time exceeds the threshold time period for starvation.

18. The method according to claim 16 including moving the contents of the primary LIFO memory stack to the backup LIFO memory stack using atomic instructions upon the determination that the differential time exceeds the threshold time period for starvation.

19. Apparatus for configuring a pseudo-FIFO (first in, first out) memory, said apparatus comprising:
means for operating a first memory portion as a primary last in, first out (LIFO) memory stack using atomic instructions;
means for detecting a starvation condition in said primary LIFO memory stack; and
means for operating a second memory portion as a backup LIFO memory stack using atomic instructions upon said detection of the starvation condition.

20. The apparatus according to claim 19 including:
means for storing producer work items in the primary LIFO; and
means for retrieving consumer work items from one of the primary and backup LIFO memory stacks dependent on the detection of the starvation condition.
